(19) United States
(12) Patent Application Publication
(10) Pub. No.: US 2020/0205252 A1
(43) Pub. Date: Jun. 25, 2020

(54) ILLUMINATION SYSTEM COMPRISING FIRST LIGHTING DEVICE SETS, SEQUENCE CONTROL UNITS, BLUETOOTH SEQUENCE CONTROL DEVICE, AND COMMUNICATION PATHS

(71) Applicant: MING-TSUNG CHEN, Taipei City (TW)

(72) Inventor: MING-TSUNG CHEN, Taipei City (TW)

(21) Appl. No.: 16/228,954

(22) Filed: Dec. 21, 2018

(51) Int. Cl. H05B 37/02; H05B 33/08

(52) U.S. Cl. CPC H05B 37/0272; H05B 37/0254; H05B 33/0845

(57) ABSTRACT

An illumination system includes a first lighting device set, a second lighting device set, and a Bluetooth sequence control device. One of a plurality of sequence control units of a plurality of lighting devices of the first lighting device set is connected to one of a plurality of sequence control units of a plurality of lighting devices of the second lighting device set through a first communication path. One of the plurality of sequence control units of the plurality of lighting devices of the first lighting device set is connected to one of the plurality of sequence control units of the plurality of lighting devices of the second lighting device set through a second communication path.

### FIELD OF THE DISCLOSURE

The present disclosure relates to an illumination system, and more particularly to an illumination system in which lighting devices can communicate with each other.

### BACKGROUND OF THE DISCLOSURE

Recently, light emitting diode lamps have become popular. However, the way of controlling or dimming light emitting diode lamps is limited to a single communication path. If the single communication path is disconnected or damaged, control signals or dimming signals cannot be transmitted to each of the light emitting diode lamps.

Therefore, it has become an important issue in the art to provide an illumination system that has more than one communication path.

### SUMMARY OF THE DISCLOSURE

In response to the above-referenced technical inadequacies, the present disclosure provides an illumination system. In one aspect, the illumination system includes a first lighting device set, a second lighting device set and a Bluetooth sequence control device. The first lighting device set includes a plurality of lighting devices, and each of the lighting devices includes at least one sequence control unit. The second lighting device set includes a plurality of lighting devices, and each of the lighting devices includes at least one sequence control unit. The sequence control units of the plurality of lighting devices of the first lighting device set are electrically connected to the Bluetooth sequence device. The sequence control units of the plurality of lighting devices of the second lighting device set are electrically connected to the Bluetooth sequence device. One of the sequence control units of the plurality of lighting devices of the first lighting device set is connected to one of the sequence control units of the plurality of lighting devices of the second lighting device set through a first communication path. One of the sequence control units of the plurality of lighting devices of the first lighting device set is connected to one of the sequence control units of the plurality of lighting devices of the second lighting device set through a second communication path.

Therefore, the illumination system of the present disclosure uses the sequence control unit of the lighting device to communicate, and has two communication paths. When one of the communication paths is disconnected or damaged, another communication path can still be used, so that the efficiency of error handling can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a lighting device according to an embodiment of the present disclosure.

FIG. 2 is a schematic view of a plurality of lighting devices according to an embodiment of the present disclosure.

FIG. 3 is a schematic view of an illumination system according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

An illumination system and a lighting device will be described in conjunction with the drawings in at least one embodiment. However, the following embodiments are not intended to limit the present disclosure. In the following description, for an electronic component having two or more terminals, if the pins corresponding to the terminals are marked, the pins are designated according to the description conveyed by the marks. If the pins are not marked, the terminal on the left side of a laterally disposed two-terminal electronic component would serve as a first terminal, while the terminal on the right side of the same would serve as a second terminal. In the same sense, the terminal on the top side of a vertically disposed two-terminal electronic component would serve as a first terminal, while the terminal on the bottom side of the same would serve as a second terminal.

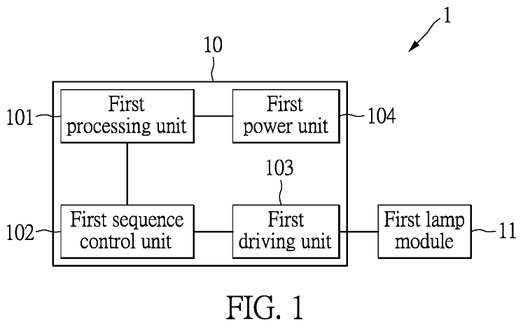

Referring to FIG. 1, FIG. 1 is a schematic view of a lighting device according to an embodiment of the present disclosure. A first lighting device 1 includes a first sequence driving module 10 and a first lamp module 11.

The first sequence driving module 10 includes a first processing unit 101, a first sequence control unit 102, a first driving unit 103, and a first power unit 104.

The first processing unit 101 is electrically connected to the first power unit 104 and the first sequence control unit 102. The first sequence control unit 102 is electrically connected to the first driving unit 103. The first power unit 104 is electrically connected to the first driving unit 103.

The first sequence driving module 10 is electrically connected to a first lamp module 11 through the first driving unit 103.

In this embodiment, the first driving unit 103 includes at least one constant current driver (not shown in the drawings). That is, the first lamp module 11 only includes a plurality of light emitting diode units (not shown) and a circuit board (not shown) and does not include a driving circuit. The plurality of light emitting diode units (not shown) of the first lamp module 11 are disposed on the circuit board to electrically connect to the first driving unit 103.

The first driving unit 103 is disposed in the first sequence driving module 10. The number of the lamp modules can be adjusted according to particular requirements, and is not limited in the present disclosure. In addition, the number of the first driving unit 103 of the first sequence driving module 10 can be correspondingly increased or the driving ability of the first driving unit 103 of the first sequence driving module 10 can be adjusted according to the number of the lamp modules, and are not limited in the present disclosure.

In this embodiment, the power unit 104 includes an AC-DC converter or a DC-DC converter, which can be designed and adjusted according to particular requirements and is not limited in the present disclosure.

The first sequence control unit 102 includes an RS232 controller or an RS485 controller, which can be adjusted and designed according to particular requirements and is not limited in the present disclosure. In this embodiment, the first sequence control unit 102 is an RS232 controller.

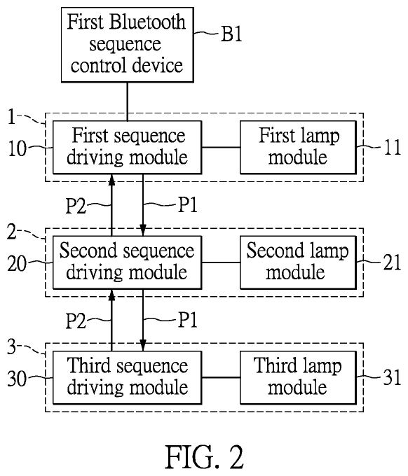

Referring to FIG. 2, FIG. 2 is a schematic view of a plurality of lighting devices communicating with each other according to an embodiment of the present disclosure.

In this embodiment, the first lighting device 1, a second lighting device 2 and a third lighting device 3 communicate with each other through a first communication path P1 and a second communication path P2.

In this embodiment, the first lighting device 1 includes the first sequence driving module 10 and the first lamp module 11. The second lighting device 2 includes a second driving module 20 and a second lamp module 21. The third lighting device 3 includes a third sequence driving module 30 and a third lamp module 31.

As described above, the first sequence driving module 10 is electrically connected to the first lamp module 11. The second sequence driving module 20 is electrically connected to the second lamp module 21. The third sequence driving module 30 is electrically connected to the third lamp module 31.

In this embodiment, the first sequence driving module 10 includes the first processing unit 101, the first sequence control unit 102, the first driving unit 103, and the first power unit 104. The first processing unit 101 is electrically connected to the first power unit 104 and the first sequence control unit 102. The first sequence control unit 102 is electrically connected to the first driving unit 103. The first power unit 104 is electrically connected to the first driving unit 103. The first sequence driving module 10 is electrically connected to the first lamp module 11 through the first driving unit 103.

The second sequence driving module 20 includes a second processing unit (not shown), a second sequence control unit (not shown), a second driving unit (not shown), and a second power unit (not shown). The second processing unit is electrically connected to the second power unit and the second sequence control unit. The second sequence control unit is electrically connected to the second driving unit. The second power unit is electrically connected to the second driving unit. The second sequence driving module 20 is electrically connected to the second lamp module 21 through the second driving unit.

The third sequence driving module 30 includes a third processing unit (not shown), a third sequence control unit (not shown), a third driving unit (not shown), and a third power unit (not shown). The third processing unit is electrically connected to the third power unit and the third sequence control unit. The third sequence control unit is electrically connected to the third driving unit. The third power unit is electrically connected to the third driving unit. The third sequence driving module 30 is electrically connected to the third lamp module through the third driving unit.

In this embodiment, the first sequence control unit 102 of the first sequence driving module 10 is electrically connected to a first Bluetooth sequence control device B1. The first sequence control unit 102 of the first sequence driving module 10 is electrically connected to the second sequence control unit of the second sequence driving module 20 through the first communication path P1 and the second communication path P2. The second sequence control unit of the second sequence driving module 20 is electrically connected to the third sequence control unit of the third sequence driving module 30 through the first communication path P1 and the second communication path P2. The first Bluetooth sequence control device B1 communicates with a server (not shown).

In this embodiment, the first communication path P1 and the second communication path P2 are wired communication paths, respectively. The first sequence driving module 10, the second sequence driving module 20 and the third sequence driving module 30 can transmit signals through the first communication path P1 according to a first order. The first order is an order in which the first sequence driving module 10, the second sequence driving module 20 and the third sequence driving module 30 sequentially transmit signals.

Further, the first sequence driving module 10, the second sequence driving module 20 and the third sequence driving module 30 can transmit signals through the second communication path P2 according to a second order. In this embodiment, the second order is an order in which the third sequence driving module 30, the second sequence driving module 20 and the first sequence driving module 10 sequentially transmit signals.

According to the above, the first order and the second order are opposite orders of signal transmission. In this embodiment, the first sequence driving module 10, the second sequence driving module 20 and the third sequence driving module 30 can transmit a first type signal through the first communication path P1 according to the first order. The first sequence driving module 10, the second sequence driving module 20 and the third sequence driving module 30 can transmit a second type signal through the communication path P2 according to the second order. The first type signal and the second type signal may be a start signal or a dimming signal, which can be adjusted according to particular requirements and is not limited in the present disclosure.

When the first communication path P1 between the first sequence driving module 10, the second sequence driving module 20 and the third sequence driving module 30 is disconnected, the first sequence driving module 10, the second sequence driving module 20 and the third sequence driving module 30 can transmit signals through the second communication path P2. The first sequence driving module 10, the second sequence driving module 20 and the third sequence driving module 30 can also transmit a fault signal through the second communication path P2 so that a user can repair the first communication path P1 according to the fault signal.

Similarly, when the second communication path P2 between the first sequence driving module 10, the second sequence driving module 20 and the third sequence driving module 30 is disconnected, the first sequence driving module 10, the second sequence driving module 20 and the third sequence driving module 30 can transmit signals through the first communication path P1. The first sequence driving module 10, the second sequence driving module 20 and the third sequence driving module 30 can also transmit a fault signal through the first communication path P1 so that the user can repair the second communication path P2 according to the fault signal.

For example, when the first communication path P1 between the second sequence driving module 20 and the third communication sequence driving module 30 is disconnected, the second sequence driving module 20 can transmit signals through the second communication path P2 of the second sequence driving module 20 and the third communication sequence driving module 30. The second sequence driving module 20 transmits a fault signal to the first Bluetooth sequence control device B1 through the second communication path P2, and the first Bluetooth sequence control device B1 transmits the fault signal to a server (not shown) to notify the user so that the user can repair the first communication path P1 according to the fault signal.

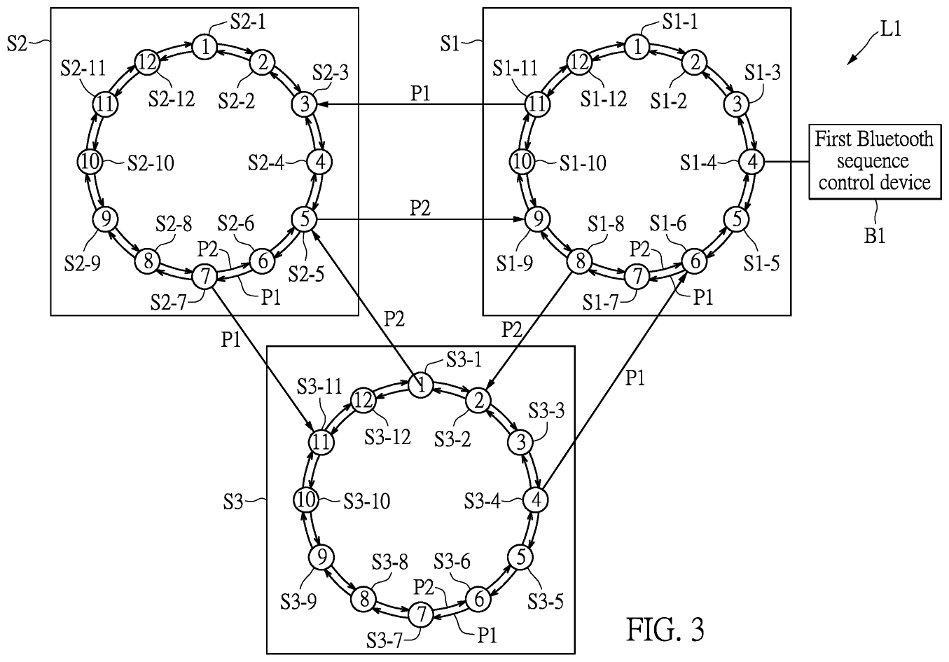

Referring to FIG. 3, FIG. 3 is a schematic view of an illumination system according to an embodiment of the present disclosure.

In this embodiment, an illumination system L1 includes a first lighting device set S1, a second lighting device set S2, and a third lighting device set S3.

The first lighting device set S1 includes a first lighting device S1-1, a second lighting device S1-2, a third lighting device S1-3, a fourth lighting device S1-4, a fifth lighting device S1-5, a sixth lighting device S1-6, a seventh lighting device S1-7, an eighth lighting device S1-8, a ninth lighting device S1-9, a tenth lighting device S1-10, an eleventh lighting device S1-11, and a twelfth lighting device S1-12.

The second lighting device set S2 includes a first lighting device S2-1, a second lighting device S2-2, a third lighting device S2-3, a fourth lighting device S2-4, a fifth lighting device S2-5, a sixth lighting device S2-6, a seventh lighting device S2-7, an eighth lighting device S2-8, a ninth lighting device S2-9, a tenth lighting device S2-10, an eleventh lighting device S2-11, and a twelfth lighting device S2-12.

The third lighting device set S3 includes a first lighting device S3-1, a second lighting device S3-2, a third lighting device S3-3, a fourth lighting device S3-4, a fifth lighting device S3-5, a sixth lighting device S3-6, a seventh lighting device S3-7, an eighth lighting device S3-8, a ninth lighting device S3-9, a tenth lighting device S3-10, an eleventh lighting device S3-11, and a twelfth lighting device S3-12.

The plurality of lighting devices S1-1 to S1-12 of the first lighting device set S1 communicate through the first communication path P1 and the second communication path P2, respectively.

That is to say, sequence driving modules (not shown) of the plurality of lighting devices S1-1 to S1-12 of the first lighting device set S1 communicate through the first communication path P1 and the second communication path P2, respectively. Further, the plurality of lighting devices S1-1 to S1-12 of the first lighting device set S1 can transmit the first type signal and the second type signal through the first communication path P1 and the second communication path P2, respectively.

In this embodiment, the first type signal and the second type signal may be a start signal or a dimming signal, which can be adjusted according to particular requirements and is not limited in the present disclosure.

In addition, the plurality of lighting devices S1-1 to S1-12 of the first lighting device set S1 transmit the first type signal in the first order through the first communication path P1. The plurality of lighting devices S1-1 to S1-12 of the first lighting device set S1 transmit the second type signal in the second order through the second communication path P2.

In this embodiment, the first order is an order in which a first sequence driving module (not shown) of the first lighting device S1-1, a second sequence driving module (not shown) of the second lighting device S1-2, a third sequence driving module (not shown) of the third lighting device S1-3, a fourth sequence driving module (not shown) of the fourth lighting device S1-4, a fifth sequence driving module (not shown) of the fifth lighting device S1-5, a sixth sequence driving module (not shown) of the sixth lighting device S1-6, a seventh sequence driving module (not shown) of the seventh lighting device S1-7, an eighth sequence driving module (not shown) of the eighth lighting device S1-8, a ninth sequence driving module (not shown) of the ninth lighting device S1-9, a tenth sequence driving module (not shown) of the tenth lighting device S1-10, an eleventh sequence driving module (not shown) of the eleventh lighting device S1-11, and a twelfth sequence driving module (not shown) of the twelfth lighting device S1-12 sequentially transmit signals.

In this embodiment, the second order is an order in which the twelfth sequence driving module (not shown) of the twelfth lighting device S1-12, the eleventh sequence driving module (not shown) of the eleventh lighting device S1-11, the tenth sequence driving module (not shown) of the tenth lighting device S1-10, the ninth sequence driving module (not shown) of the ninth lighting device S1-9, the eighth sequence driving module (not shown) of the eighth lighting device S1-8, the seventh sequence driving module (not shown) of the seventh lighting device S1-7, the sixth sequence driving module (not shown) of the sixth lighting device S1-6, the fifth sequence driving module (not shown) of the fifth lighting device S1-5, the fourth sequence driving module (not shown) of the fourth lighting device S1-4, the third sequence driving module (not shown) of the third lighting device S1-3, the second sequence driving module (not shown) of the second lighting device S1-2, the first sequence driving module (not shown) of the first lighting device S1-1 sequentially transmit signals.

In this embodiment, the number and reference numerals of the lighting devices can be adjusted according to particular requirements, and are not limited in the present disclosure.

In FIG. 3, the plurality of lighting devices of each of the lighting device sets communicate with each other in a cyclic manner. That is, the first sequence driving module of the first lighting device S1-1 is electrically connected to the twelfth sequence driving module of the twelfth lighting device S1-12. Namely, in this embodiment, the manner of communication in the first lighting device set S1 is cyclic communication. Moreover, since the first lighting device set S1 has two communication paths (the first communication path P1 and the second communication path P2) having different transmission orders, the plurality of lighting devices S1-1 to S1-12 of the first lighting device set S1 can be connected in dual cyclic communication.

In other embodiments, the first sequence driving module (not shown) of the first lighting device S1-1 can be non-electrically connected to the twelfth sequence driving module (not shown) of the twelfth lighting device S1-12. That is, the plurality of lighting devices S1-1 to S1-12 of the first lighting device set S1 can be connected in open communication.

In this embodiment, when the first communication path P1 between the first lighting device S1-1 to the twelfth lighting device S1-12 is disconnected, the first lighting device S1-1 to the twelfth lighting device S1-12 can transmit signals through the second communication path P2. The first lighting device S1-1 to the twelfth lighting device S1-12 can further transmit a fault signal through the second communication path P2 to the first Bluetooth sequence control device B1. The first Bluetooth sequence control device B1 transmits the fault signal to a server (not shown) to notify the user so that the user can repair the first communication path P1.

In this embodiment, when the second communication path P2 between the first lighting device S1-1 to the tenth lighting device S1-10 is disconnected, the first lighting device S1-1 to the tenth lighting device S1-10 can transmit signals through the first communication path P1. The first lighting device S1-1 to the tenth lighting device S1-10 can further transmit a fault signal through the first communication path P1 to the first Bluetooth sequence control device B1. The first Bluetooth sequence control device B1 transmits the fault signal to a server (not shown) to notify the user so that the user can repair the second communication path P2.

In this embodiment, the structures and ways of communication connection of the plurality of lighting devices S2-1 to S2-10 of the second lighting device set S2 and the plurality of lighting devices S3-1 to S3-10 of the third lighting device set S3 are the same, and the detailed description will be omitted herein.

In this embodiment, the eleventh sequence driving module (not shown) of the eleventh lighting device S1-11 of the first lighting device set S1 communicates with the third sequence driving module (not shown) of the third lighting device S2-3 of the second lighting device set S2 through the first communication path P1. The seventh sequence driving module (not shown) of the seventh lighting device S2-7 of the second lighting device set S2 communicates with the eleventh sequence driving module (not shown) of the eleventh lighting device S3-11 of the third lighting device set S3 through the first communication path P1. The fourth sequence driving module (not shown) of the fourth lighting device S3-4 of the third lighting device set S3 communicates with the sixth sequence driving module (not shown) of the sixth lighting device S1-6 of the first lighting device set S1 through the first communication path P1.

In this embodiment, the eighth sequence driving module (not shown) of the eighth lighting device S1-8 of the first lighting device set S1 communicates with the second sequence driving module (not shown) of the second lighting device S3-2 of the third lighting device set S3 through the second communication path P2. The first sequence driving module (not shown) of the first lighting device S3-1 of the third lighting device set S3 communicates with the fifth sequence driving module (not shown) of the fifth lighting device S2-5 of the second lighting device set S2 through the second communication path P2. The fifth sequence driving module (not shown) of the fifth lighting device S2-5 of the second lighting device set S2 communicates with the ninth sequence driving module (not shown) of the ninth lighting device S1-9 of the first lighting device set S1 through the second communication path P2.

Therefore, the lighting device sets can have the communication connection as same as the abovementioned communication connection between the lighting devices in the lighting device sets, namely, having the first communication path P1 and the second communication path P2 to transmit different signals respectively.

In addition, in this embodiment, when the first communication path P1 between the first lighting device set S1, the second lighting device S2 and the third lighting device set S3 is disconnected, the first lighting device set S1, the second lighting device S2 and the third lighting device set S3 can transmit signals through the second communication path P2. The first lighting device set S1, the second lighting device S2 and the third lighting device set S3 can further transmit a fault signal to the first Bluetooth sequence control device B1 through the second communication path P2. The first Bluetooth sequence control device B1 transmits the fault signal to a server (not shown) to notify the user so that the user can repair the first communication path P1 according to the fault signal.

Furthermore, in this embodiment, when the second communication path P2 between the first lighting device set S1, the second lighting device S2 and the third lighting device set S3 is disconnected, the first lighting device set S1, the second lighting device S2 and the third lighting device set S3 can transmit signals through the first communication path P1. The first lighting device set S1, the second lighting device S2 and the third lighting device set S3 can further transmit a fault signal to the first Bluetooth sequence control device B1 through the first communication path P1. The first Bluetooth sequence control device B1 transmits the fault signal to a server (not shown) to notify the user so that the user can repair the second communication path P2 according to the fault signal.

In this embodiment, the first lighting device set S1, the second lighting device S2 and the third lighting device set S3 are disposed in different regions, but they can also be disposed in the same region, which is not limited in the present disclosure. In addition, the number of the lighting device sets can be adjusted according to particular requirements and is not limited in the present disclosure.

Based on the above, the illumination system of the present disclosure uses the sequence control unit of the lighting device to communicate, and has two communication paths. When one of the communication paths is disconnected or damaged, another communication path can still be used, so that the efficiency of error handling can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. An illumination system, comprising:
a first lighting device set including a plurality of lighting devices, each of which including at least one sequence control unit;
a second lighting device set including a plurality of lighting devices, each of which including at least one sequence control unit; and
a Bluetooth sequence control device, the sequence control units of the plurality of lighting devices of the first lighting device set being electrically connected to the Bluetooth sequence device, the sequence control units of the plurality of lighting devices of the second lighting device set electrically being connected to the Bluetooth sequence device;
wherein one of the sequence control units of the plurality of lighting devices of the first lighting device set is connected to one of the sequence control units of the plurality of lighting devices of the second lighting device set through a first communication path;
wherein one of the sequence control units of the plurality of lighting devices of the first lighting device set is connected to one of the sequence control units of the plurality of lighting devices of the second lighting device set through a second communication path;
wherein each of the lighting devices further includes:
a sequence driving module including a processing unit, a power unit, and a driving unit, wherein the processing unit is electrically connected to the sequence control unit, and the sequence control unit is electrically connected to the driving unit; and
a lamp module including a plurality of light emitting diode units and a circuit board, the lamp module is electrically connected to the driving unit.

2. The illumination system according to claim 1, wherein the sequence control units of the plurality of lighting devices of the first lighting device set and the second lighting device set respectively communicate through the first communication path and the second communication path.

3. The illumination system according to claim 1, wherein the lighting devices of the first lighting device set and the second device set apply cyclic communication.

4. (canceled)

5. The illumination system according to claim 2, wherein the sequence control units of the plurality of lighting device of the first lighting device set transmit signals in a first order or a second order.

6. The illumination system according to claim 5, wherein the first order and the second order are opposite orders.

7. An illumination system, comprising:
a first lighting device set including a plurality of lighting devices, each of which including at least one sequence control unit;
a second lighting device set including a plurality of lighting devices, each of which including at least one sequence control unit; and
a Bluetooth sequence control device, the sequence control units of the plurality of lighting devices of the first lighting device set being electrically connected to the Bluetooth sequence device, the sequence control units of the plurality of lighting devices of the second lighting device set electrically being connected to the Bluetooth sequence device;
wherein one of the sequence control units of the plurality of lighting devices of the first lighting device set is connected to one of the sequence control units of the plurality of lighting devices of the second lighting device set through a first communication path;
wherein one of the sequence control units of the plurality of lighting devices of the first lighting device set is connected to one of the sequence control units of the plurality of lighting devices of the second lighting device set through a second communication path;
wherein the sequence control units of the plurality of lighting devices of the first lighting device set and the second lighting device set respectively communicate through the first communication path and the second communication path;
wherein the sequence control units of the plurality of lighting device of the first lighting device set transmit signals in a first order or a second order.
